(19) United States
(12) Patent Application Publication
(10) Pub. No.: US 2026/0241377 A1
(43) Pub. Date: Aug. 20, 2026

(54) METHOD OF PASSIVATING A FISCHER-TROPSCH CATALYST

(71) Applicant: Johnson Matthey Davy Technologies Limited, London (GB)

(72) Inventors: Jilliann CLAPP, Stockton-On-Tees (GB); Jay Simon CLARKSON, Stockton-On-Tees (GB); Andrew James COE, London (GB)

(21) Appl. No.: 19/162,569

(22) PCT Filed: Apr. 25, 2024
(86) PCT No.: PCT/GB2024/051084

§ 371 Date: Sep. 5, 2025

(30) Foreign Application Priority Data
May 10, 2023 (GB) 2306879.4

(51) Int. Cl. B01J 38/14; B01J 23/75; B01J 23/94; B01J 33/00; B01J 38/02

(52) U.S. Cl. CPC B01J 38/14; B01J 23/75; B01J 23/94; B01J 33/00; B01J 38/02

(57) ABSTRACT

A method of passivating a Fischer-Tropsch catalyst in a catalyst carrier disposed within a Fischer-Tropsch reactor, the method comprising: providing a Fischer-Tropsch catalyst in a catalyst carrier disposed within a Fischer-Tropsch reactor, the Fischer-Tropsch reactor having an inlet and an outlet, the Fischer-Tropsch catalyst having hydrocarbons on its surface; contacting the Fischer-Tropsch catalyst with a gas, the gas passed into the inlet having a first oxygen content; and while maintaining the flow of gas: adjusting the temperature of the Fischer-Tropsch catalyst to strip hydrocarbons from the surface of the Fischer-Tropsch catalyst; removing stripped hydrocarbons from the catalyst carrier and the Fischer-Tropsch reactor; adjusting the temperature of the Fischer-Tropsch catalyst; increasing the oxygen content of the gas; cooling the catalyst; and increasing the oxygen content of the gas passed to the inlet, wherein: the gas passed into the inlet having the first oxygen content is an inert.

### FIELD OF THE INVENTION

The invention relates to a method of passivating a Fischer-Tropsch catalyst.

### BACKGROUND OF THE INVENTION

A well-known process for producing hydrocarbons at industrial scale is the Fischer-Tropsch process in which a mixture of carbon monoxide and hydrogen is reacted in the presence of a catalyst in a reactor to produce reaction products comprising hydrocarbons.

These reactions occur in the presence of metal catalysts, typically at temperatures of 150-300° C. and pressures of one to several tens of atmospheres. The Fischer-Tropsch process involves a series of chemical reactions that produce a variety of hydrocarbons, ideally having the formula (CₙH₂ₙ₊₂). The more useful reactions produce alkanes as follows:

$$( 2 n + 1 ) {H}_{2} + n CO \to {C}_{n} {H}_{2 n + 2} + n {H}_{2} O$$

The formation of methane (n=1) is unwanted. Most of the useful alkanes produced tend to be straight-chain liquids, suitable as fuel. In addition to alkane formation, competing reactions give small amounts of alkenes, as well as alcohols and other oxygenated hydrocarbons. The Fischer-Tropsch reaction is a highly exothermic reaction due to a standard reaction enthalpy (ΔH) of −165 KJ/mol CO combined.

WO2012146903 discloses a process for the conversion of synthesis gas to higher hydrocarbons by contacting a gaseous stream comprising synthesis gas with a particulate Fischer-Tropsch catalyst, said process being carried out in a tubular reactor, said reactor comprising one or more tubes having located therein one or more carriers for said particulate catalyst.

After performing the Fischer-Tropsch reaction, there will be a point where the catalyst will need to be removed from the reactor for regeneration or reprocessing. However, this can pose a safety hazard as the catalyst, which is typically coated in hydrocarbons such as wax, is susceptible to exothermic oxidation in air, resulting in a potential fire-risk. Accordingly, prior to removal of the catalyst from the reactor, hydrocarbons need to be removed from the catalyst and the catalyst needs to undergo at least partial oxidation to passivate the reactive metal components of the Fischer-Tropsch catalyst.

Methods of passivating a Fischer-Tropsch catalyst in situ are described in WO2012085227A1, WO2010069978A1, U.S. Pat. No. 9,556,570B2 and GB2222531A. Such methods require the use of solvent to remove hydrocarbons from the catalyst followed by contacting the catalyst with an oxygen stream at elevated temperatures. The use of solvent increases the environmental impact of the methods and results in a waste stream requiring treatment or disposal. Furthermore, unless substantially all of the hydrocarbons are removed from the catalyst, contacting the catalyst with the oxygen stream has the potential to result in exothermic oxidation that may increase the temperature of the catalyst to dangerously high levels.

The present invention seeks to tackle at least some of the problems associated with the prior art or at least to provide a commercially acceptable alternative solution thereto.

### SUMMARY OF THE INVENTION

One aspect of the present disclosure is directed to a method of passivating a Fischer-Tropsch catalyst in a catalyst carrier disposed within a Fischer-Tropsch reactor, the method comprising:
providing a Fischer-Tropsch catalyst in a catalyst carrier disposed within a Fischer-Tropsch reactor, the Fischer-Tropsch reactor having an inlet and an outlet with the catalyst carrier disposed between the inlet and the outlet, the Fischer-Tropsch catalyst having hydrocarbons on its surface;
contacting the Fischer-Tropsch catalyst with a gas by passing a flow of the gas into the inlet, through the catalyst carrier, and then out of the outlet, the gas passed into the inlet having a first oxygen content; and
while maintaining the flow of gas:
   adjusting the temperature of the Fischer-Tropsch catalyst to a first temperature of from 100 to 280° C. to strip hydrocarbons from the surface of the Fischer-Tropsch catalyst;
   removing stripped hydrocarbons from the catalyst carrier and the Fischer-Tropsch reactor;
   adjusting the temperature of the Fischer-Tropsch catalyst to a second temperature of from 100 to 180° C.;
   increasing the oxygen content of the gas passed to the inlet to a second oxygen content;
   cooling the catalyst carrier to below 40° C.; and
   increasing the oxygen content of the gas passed to the inlet to a third oxygen content,
      wherein:
the gas passed into the inlet having the first oxygen content is an inert gas;
the first oxygen content is less than 0.1 mol. % oxygen;
the second oxygen content is from 0.1 to 15 mol. % oxygen; and
the third oxygen content is greater than 15 mol. % oxygen.

### BRIEF DESCRIPTION OF THE DRAWINGS

FIG. 1 is a depiction of one embodiment of a system to which the method of the present invention may be applied; and

FIG. 2 is a chart illustrating the passivation of a cobalt containing catalyst in a carrier showing mole-percent of oxygen and carbon dioxide and catalyst temperature during the passivation process.

### DETAILED DESCRIPTION OF THE INVENTION

The present disclosure is directed to a method of passivating a Fischer-Tropsch catalyst in a catalyst carrier disposed within a Fischer-Tropsch reactor, the method comprising:
providing a Fischer-Tropsch catalyst in a catalyst carrier disposed within a Fischer-Tropsch reactor, the Fischer-Tropsch reactor having an inlet and an outlet with the catalyst carrier disposed between the inlet and the outlet, the Fischer-Tropsch catalyst having hydrocarbons on its surface;
contacting the Fischer-Tropsch catalyst with a gas by passing a flow of the gas into the inlet, through the catalyst carrier, and then out of the outlet, the gas passed into the inlet having a first oxygen content; and
while maintaining the flow of gas:
   adjusting the temperature of the Fischer-Tropsch catalyst to a first temperature of from 100 to 280° C. to strip hydrocarbons from the surface of the Fischer-Tropsch catalyst;
   removing stripped hydrocarbons from the catalyst carrier and the Fischer-Tropsch reactor;
   adjusting the temperature of the Fischer-Tropsch catalyst to a second temperature of from 100 to 180° C.;
   increasing the oxygen content of the gas passed to the inlet to a second oxygen content;
   cooling the catalyst carrier to below 40° C.; and
   increasing the oxygen content of the gas passed to the inlet to a third oxygen content,
      wherein:
the gas passed into the inlet having the first oxygen content is an inert gas;
the first oxygen content is less than 0.1 mol. % oxygen;
the second oxygen content is from 0.1 to 15 mol. % oxygen; and
the third oxygen content is greater than 15 mol. % oxygen.

Each aspect or embodiment as defined herein may be combined with any other aspect(s) or embodiment(s) unless clearly indicated to the contrary. In particular, any features indicated as being preferred or advantageous may be combined with any other feature indicated as being preferred or advantageous.

Advantageously, in contrast to conventional methods, the method of the present invention may remove hydrocarbons from the catalyst without the use of solvents. The Applicant has found that it is not necessary to wash hydrocarbon from the pores of the catalyst in order to achieve a satisfactory catalyst passivation prior to discharge from the Fischer-Tropsch reactor. Accordingly, in contrast to conventional methods, the method of the present invention may be more environmentally friendly and/or lower cost and may not require the treatment and/or disposal of a solvent waste stream.

Surprisingly, although hydrocarbon may remain in the pores of the catalyst, the use of the inert gas to strip hydrocarbons from the catalyst surface may result in the stripped catalyst being free-flowing. This may render the stripped catalyst easier to remove from the catalyst carrier.

The method involves passivating a Fischer-Tropsch catalyst. Fischer-Tropsch catalysts are known in the art. The Fischer-Tropsch catalyst may be in the form of catalyst particles. The Fischer-Tropsch catalyst may comprise a catalytically active metal and optionally promoters, supported on a catalyst support material. The catalyst support material may comprise a metal oxide, preferably a porous metal oxide.

In the present invention, the Fischer-Tropsch catalyst is provided in a catalyst carrier. Suitable catalyst carriers are known in the art. The catalyst carrier may be in the form of, for example, a vessel as described in WO2012146903 or WO2016050520. The catalyst carrier may be formed of, for example, steel, preferably stainless steel.

The catalyst carrier is disposed within a Fischer-Tropsch reactor. Fischer-Tropsch reactors are known in the art. The Fischer-Tropsch reactor has an inlet and an outlet with the catalyst carrier disposed between the inlet and the outlet. By being disposed in the catalyst carrier, the catalyst is in fluid communication with both the inlet and the outlet.

The hydrocarbons on the surface of the Fischer-Tropsch catalyst are typically solid or liquid at room temperature and pressure. The hydrocarbons typically comprise wax. Such hydrocarbons are typically produced during a Fischer-Tropsch reaction.

The method comprises contacting the Fischer-Tropsch catalyst with a gas by passing a flow of the gas into the inlet, through the catalyst carrier, and then out of the outlet. As will be appreciated, the catalyst carrier will have an inlet and an outlet to enable gas to be passed therethrough.

The gas passed into the inlet has a first oxygen content. The first oxygen content of the gas is preferably maintained until the oxygen content is increased to the second oxygen content.

The method comprises steps during which the flow of gas is maintained. By “maintained” it is meant that gas continues to flow during those steps. The rate of flow preferably remains substantially constant during such “maintaining” but does not have to remain constant.

The method comprises adjusting the temperature of the Fischer-Tropsch catalyst to a first temperature of from 100 to 280° C. for the flow of gas to strip hydrocarbons from the surface of the Fischer-Tropsch catalyst. Lower temperatures may be insufficient to melt hydrocarbons such as wax, meaning that unfavourably high levels of wax remain on the catalyst. Higher temperatures are unnecessary and may volatilise the wax, meaning that it is harder to remove from the Fischer-Tropsch reactor using conventional methods, such as the use of a gas-liquid separator.

The method comprises removing stripped hydrocarbons from the catalyst carrier and the Fischer-Tropsch reactor. This may avoid oxidation of the stripped hydrocarbons when the oxygen content of the gas is subsequently increased. This may reduce the risk of fire and/or the temperature of the catalyst reaching a dangerously high level. The stripped hydrocarbons may then be disposed of or subjected to a separation and/or refining process.

The method comprises adjusting the temperature of the Fischer-Tropsch catalyst to a second temperature of from 100 to 180° C. and then increasing the oxygen content of the gas passed to the inlet to a second oxygen content. The temperature adjustment preferably comprises cooling the Fischer-Tropsch catalyst to the second temperature. This increase on oxygen content to the second oxygen content may result in controlled oxidation of the reactive components of the catalyst and any hydrocarbons remaining on the catalyst. Accordingly, the catalyst may subsequently be safely discharged from the catalyst carrier and/or Fischer-Tropsch reactor. Lower temperatures may result in insufficient passivation. Higher temperatures may result in an unfavourably high level of oxidation, which may increase the temperature of the catalyst and/or catalyst carrier to a dangerously high level. The second temperature is preferably lower than the first temperature.

The method further comprises cooling the catalyst carrier to below 40° C., for example to room temperature. This may enable safe removal of the catalyst and/or catalyst carrier from the Fischer-Tropsch reactor.

The method further comprises increasing the oxygen content of the gas passed to the inlet to a third oxygen content. A higher oxygen content may increase the level of passivation of the catalyst, thereby avoiding a dangerously high level of oxidation during or after discharge of the catalyst from the Fischer-Tropsch reactor.

The gas passed into the inlet having the first oxygen content is an inert gas. This may avoid significant oxidation of the catalyst and/or combustion of the hydrocarbons at the first temperature. The term “inert gas” has its usual meaning in the art and may encompass a gas that is substantially devoid of oxygen or oxidising gas, for example having less than 0.1 mol. % oxygen or oxidising gas. The gas may be inert to the extent that it does not result in significant levels of oxidation of the catalyst and/or combustion of the hydrocarbons at the first temperature. Suitable inert gases will be known to the skilled person and include nitrogen and argon.

The first oxygen content is less than 0.1 mol. % oxygen. Higher oxygen contents may result in significant levels of oxidation of the catalyst and/or combustion of the hydrocarbons at the first temperature.

The second oxygen content is from 0.1 to 15 mol. % oxygen. Lower oxygen contents may result in insignificant levels of passivation of the catalyst at the second temperature. Higher oxygen contents may results in unfavourably vigorous oxidation.

The third oxygen content is greater than 15 mol. % oxygen.

Preferably, the method further comprises measuring the oxygen content of the gas passed to the inlet and the oxygen content of the gas passed out of the outlet, and wherein increasing the oxygen content of the gas passed into the inlet to the second oxygen content is carried out in increments of no more than 2 mol. %, with the second and subsequent increments being deferred until the oxygen content of the gas passed to the inlet is substantially equal to the oxygen content of the gas passed out of the outlet. This may result in controlled oxidation or passivation of the catalyst, which may avoid the catalyst temperature increasing to a dangerously high level.

The first increment preferably increases the oxygen content to an oxygen content of from 0.1 to 0.4 mol. % oxygen, preferably from 0.2 to 0.3 mol. % oxygen. This may result in controlled oxidation of the catalyst, which may avoid the catalyst temperature increasing to a dangerously high level.

Increasing the oxygen content of the gas passed into the inlet to the second oxygen content is preferably carried out in increments of: from 0.2 to 0.8 mol. % oxygen, preferably from 0.4 to 0.6 mol. % oxygen, up to an intermediate oxygen content of from 4 to 6 mol. % oxygen; and from 0.7 to 1.7 mol. % oxygen, preferably from 0.9 to 1.1 mol. %, from the intermediate oxygen content to the second oxygen content. This may result in controlled oxidation of the catalyst, which may avoid the catalyst temperature increasing to a dangerously high level. The larger increments at the higher oxygen contents may speed up the method without risking increasing the temperature of the catalyst to a dangerously high level.

The Fischer-Tropsch catalyst preferably comprises cobalt. The method may be particularly suitable for passivating a Fischer-Tropsch catalyst comprising cobalt.

The method is preferably carried out at a pressure of from 2 to 10 barg. Lower pressures may result in inadequate oxidation or passivation of the catalyst and/or inadequate stripping of hydrocarbons from the catalyst. Higher pressures may be economically unfavourable and/or may result in an unfavourably high rate of oxidation of the catalyst.

The method is preferably carried out at a gas hourly space velocity of from 500 to 3000 h⁻¹. Lower gas hourly space velocities may result in inadequate oxidation or passivation of the catalyst and/or inadequate stripping of hydrocarbons from the catalyst. Higher gas hourly space velocities may be economically unfavourable.

Preferably, the inert gas comprises nitrogen and/or the inert gas consists essentially of nitrogen. Nitrogen is suitably inert to avoid substantial oxidation of the catalyst and/or combustion of the hydrocarbons at the first temperature. In addition, nitrogen is low cost, widely available and easy to handle.

The hydrocarbons preferably comprise wax. The method may be particularly suitable for stripping wax from a Fischer-Tropsch catalyst.

When the hydrocarbons comprise wax, removing stripped hydrocarbons from the catalyst carrier and the Fischer-Tropsch reactor preferably comprises the use of a first gas liquid separator downstream of the Fischer-Tropsch reactor. A gas-liquid separator may be particularly effective at separating wax from the gas fed to the Fischer-Tropsch reactor. Gas-liquid separators are known in the art.

The method preferably further comprises maintaining the first temperature until substantially no more wax is collected in the first gas liquid separator, more preferably until no more wax is collected in the first gas liquid separator. This may result in the catalyst having only very low levels of wax and may render the catalyst surface substantially devoid or free of wax before the catalyst is subjected to the second temperature. This may avoid significant combustion of wax when the catalyst is subjected to the second temperature and second oxygen content.

The first oxygen content is preferably less than or equal to 0.01 mol. % oxygen. Such an oxygen content may be particularly suitable for avoiding significant levels of oxidation of the catalyst and/or combustion of the hydrocarbons at the first temperature.

The first temperature is preferably from 150° C. to 250° C. Such temperatures are particularly suitable for melting wax while avoiding volatising the wax.

The second temperature is preferably from 110° C. to 130° C. This may result in particularly controlled oxidation or passivation of the catalyst.

The second oxygen content is preferably from 8 to 12 mol. % oxygen. This may result in particularly controlled oxidation or passivation of the catalyst.

Preferably, the method further comprises, after increasing the oxygen content of the gas passed to the inlet to a second oxygen content, maintaining the second temperature until no oxidation exotherm is observed, preferably for at least 2 hours, before cooling the catalyst carrier to below 40° C. This may ensure that a favourably high level of oxidation or passivation of the catalyst is achieved.

The third oxygen content is preferably from 20 to 22 mol. % oxygen. Such an oxygen content is similar to that of air. Accordingly, this may ensure that substantially no further oxidation of the catalyst occurs during or after discharge of the catalyst.

The gas is preferably recirculated from the outlet to the inlet. This may reduce the amount of gas required by the method, thereby decreasing the cost and avoiding the need to dispose of large volumes of gas.

Providing a Fischer-Tropsch catalyst in a catalyst carrier preferably comprises cooling the Fischer-Tropsch catalyst from an operating temperature to the first temperature. In a typical Fischer-Tropsch method, the operating temperature of the catalyst is typically higher than the first temperature.

Increasing the oxygen content of the gas preferably comprises introducing air into the inert gas. Air contains suitable amounts of oxygen and the remaining components are sufficiently inert. The use of air is lower in cost than the use of other oxygen-containing gases, such as pure oxygen.

The Fischer-Tropsch catalyst surface is preferably substantially devoid of hydrocarbons (more preferably devoid of hydrocarbons) before adjusting the temperature of the Fischer-Tropsch catalyst to the second temperature. This may avoid combustion of hydrocarbons at the second temperature, which may increase the temperature of the catalyst to a dangerously high level.

In a further aspect, the present invention provides a Fischer-Tropsch catalyst passivated according to the method described herein. Such a catalyst may exhibit a favourably high level of passivation and/or may be particularly free-flowing.

### EXAMPLES

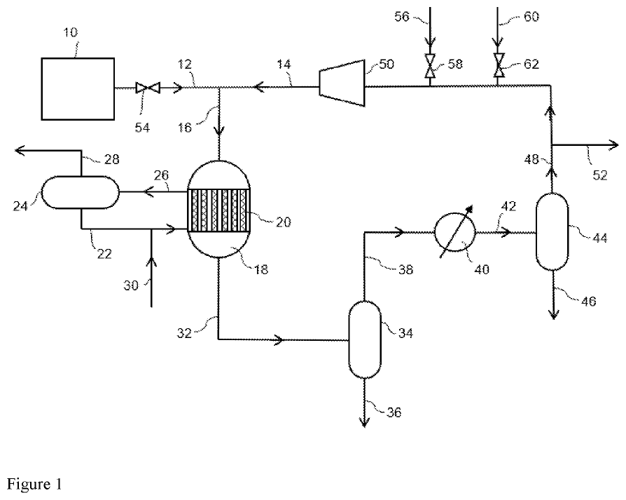

Referring to FIG. 1 there is shown a depiction of one embodiment of a system to which the method of the present invention may be applied.

It will be understood by those skilled in the art that the drawings are diagrammatic and that further items of equipment such as feedstock drums, pumps, vacuum pumps, compressors, gas recycling compressors, temperature sensors, pressure sensors, pressure relief valves, control valves, flow controllers, level controllers, holding tanks, storage tanks and the like may be required in a commercial plant. Provision of such ancillary equipment forms no part of the present invention and is in accordance with conventional chemical engineering practice.

In FIG. 1 a synthesis gas generation unit 10 produces a purified synthesis gas mixture consisting essentially of hydrogen and carbon monoxide at elevated temperature and pressure. The synthesis gas is fed from the synthesis gas generation unit 10 via line 12 and combined with a recycle stream in line 14 to produce a reactant gas mixture which is fed via line 16 to a Fischer-Tropsch reactor 18 containing a plurality of catalyst carriers containing a cobalt Fischer-Tropsch catalyst in reaction tubes 20. The tubes 20 are cooled by boiling water under pressure provided to the reactor via line 22, supplied by a steam drum 24. Steam is recovered from the Fischer-Tropsch reactor 18 via line 26 and returned to the steam drum 24. The steam drum is fed with a stream of boiler feed water (not shown) and steam is recovered from the steam drum via line 28. A supplemental steam feed line 30 is provided to line 22. Hydrocarbons are synthesis by reaction of the hydrogen and carbon monoxide over the Fischer-Tropsch catalyst. A product mixture is recovered from the Fischer-Tropsch reactor 18 via line 32 and fed to a first gas-liquid separator 34 where a liquid wax product is separated from product and unreacted gases and recovered via line 36 for optional further processing. The gaseous product and unreacted gases are fed from the first gas-liquid separator 34 via line 38 to one or more heat exchangers 40 where it is cooled to condense a mixture of co-produced water and condensable hydrocarbon products. The cooled mixture formed in the one or more heat exchangers 40 is fed via line 42 to a second gas-liquid separator 44, where the condensed water and hydrocarbons are separated and recovered via line 46 for further processing. An unreacted gas mixture comprising hydrogen, carbon monoxide and possibly carbon dioxide and/or non-condensable hydrocarbons is recovered from the second gas-liquid separator 44 via line 48 and compressed in a circulating compressor 50 to form the recycle gas stream 14. A purge line 52 is taken from the unreacted gas mixture line 48 upstream of the compressor 48.

In order to operate the passivation method, the synthesis gas feed in line 12 is shut off using valve 54, and Fischer-Tropsch reaction allowed to subside in the reaction tubes 20. Inert gas, e.g. Nitrogen gas, is fed into line 48 upstream of the circulating compressor 50 via line 56 by opening valve 58. The inert gas may be preheated. The temperature of the Fischer-Tropsch catalyst in the catalyst carriers may be controlled using the supplemental steam fed to the reactor 18 via line 30. The inert gas is desirably circulated through the reactor until the flow of hydrocarbon wax into the first gas liquid separator 34 and recovered via line 36 ceases.

At this point a flow of air, preferably a dry air such as plant air or instrument air, is fed into line 48 via a line 60 upstream of the inert gas feed line 56 by opening valve 62. The relative flow of the inert gas in line 56 and air in line 60 is controlled to provide an initial O₂ concentration of 0.25%. The oxidation exotherm in the reactor caused by the addition of O₂ is monitored by thermocouples (not shown) and the flow of steam via line 30 adjusted if necessary to maintain the temperature during the oxidation. The amount of air is increased incrementally by adjustment of valves 58 and 62.

Once no further exotherm is observed, the air circulation is increased and inert gas flow stopped by closing valve 58.

The passivated catalyst in the carriers may then be recovered from the reaction tubes 20.

An Example of the passivation method performed using the process depicted in FIG. 1 was performed by cooling the catalyst in the catalyst carriers from the Fischer-Tropsch reaction temperature to 120° C. while purging the synthesis gas from the reactor loop with nitrogen gas. The reactor pressure was reduced to 10 barg and the circulator operated to deliver the maximum gas flow at the operating pressure. The Fischer-Tropsch reactor temperature was increased at 10° C./h to 180° C. and held for 6 hours. The Fischer-Tropsch reactor was cooled to give an average catalyst temperature of 120° C. Air was introduced from an air supply to increase oxygen at the Fischer-Tropsch reactor inlet to 0.5 mol %. The introduction of air at low concentrations limits the oxidant content of the loop allowing good temperature control as the cobalt in the catalyst is oxidised. The operating temperature of 120° C. increases kinetics of oxidation but is low enough to minimise combustion of organics. Temperatures were monitored to ensure no unwanted increase in catalyst temperature, that would indicate combustion of organics. Carbon dioxide and oxygen levels were measured at the reactor inlet and exit to ensure no combustion. The oxygen content was gradually increased in 0.5 mol % increments towards 10 mol % in the Fischer-Tropsch reactor and held for 4 hours. Performing the passivation at 120° C. and a final oxygen concentration of 10 mol %, ensures sufficient oxidation of the cobalt to ensure no thermal runaway at ambient temperature when exposed to air.

Performing this procedure ensures the catalyst in the carrier is safe to handle when discharged from the reactor and the catalyst is free flowing when discharged from the carrier.

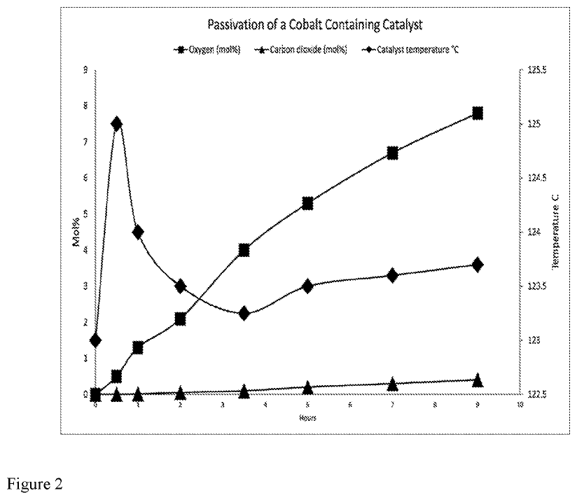

FIG. 2 shows the catalyst temperature, carbon dioxide and oxygen concentrations at the inlet to the Fischer-Tropsch reactor as the passivation progresses. The chart illustrates that the control of temperature within safe limits by the present method was achieved without combustion of hydrocarbon as shown by the low carbon dioxide levels observed.

The foregoing detailed description has been provided by way of explanation and illustration and is not intended to limit the scope of the appended claims. Many variations in the presently preferred embodiments illustrated herein will be apparent to one of ordinary skill in the art and remain within the scope of the appended claims and their equivalents.

1. A method of passivating a Fischer-Tropsch catalyst in a catalyst carrier disposed within a Fischer-Tropsch reactor, the method comprising:
providing a Fischer-Tropsch catalyst in a catalyst carrier disposed within a Fischer-Tropsch reactor, the Fischer-Tropsch reactor having an inlet and an outlet with the catalyst carrier disposed between the inlet and the outlet, the Fischer-Tropsch catalyst having hydrocarbons on its surface;
contacting the Fischer-Tropsch catalyst with a gas by passing a flow of the gas into the inlet, through the catalyst carrier, and then out of the outlet, the gas passed into the inlet having a first oxygen content; and
while maintaining the flow of gas:
adjusting the temperature of the Fischer-Tropsch catalyst to a first temperature of from 100 to 280° C. to strip hydrocarbons from the surface of the Fischer-Tropsch catalyst;
removing stripped hydrocarbons from the catalyst carrier and the Fischer-Tropsch reactor;
adjusting the temperature of the Fischer-Tropsch catalyst to a second temperature of from 100 to 180° C.;
increasing the oxygen content of the gas passed to the inlet to a second oxygen content;
cooling the catalyst carrier to below 40° C.; and
increasing the oxygen content of the gas passed to the inlet to a third oxygen content, wherein:
the gas passed into the inlet having the first oxygen content is an inert gas;
the first oxygen content is less than 0.1 mol. % oxygen;
the second oxygen content is from 0.1 to 15 mol. % oxygen; and
the third oxygen content is greater than 15 mol. % oxygen.

2. The method of claim 1, wherein the method further comprises measuring the oxygen content of the gas passed to the inlet and the oxygen content of the gas passed out of the outlet, and wherein increasing the oxygen content of the gas passed into the inlet to the second oxygen content is carried out in increments of no more than 2 mol. %, with the second and subsequent increments being deferred until the oxygen content of the gas passed to the inlet is substantially equal to the oxygen content of the gas passed out of the outlet.

3. The method of claim 2, wherein the first increment increases the oxygen content to an oxygen content of from 0.1 to 0.4 mol. % oxygen, preferably from 0.2 to 0.3 mol. % oxygen.

4. The method of claim 2, wherein increasing the oxygen content of the gas passed into the inlet to the second oxygen content is carried out in increments of:
from 0.2 to 0.8 mol. % oxygen, preferably from 0.4 to 0.6 mol. % oxygen, up to an intermediate oxygen content of from 4 to 6 mol. % oxygen; and
from 0.7 to 1.7 mol. % oxygen, preferably from 0.9 to 1.1 mol. %, from the intermediate oxygen content to the second oxygen content.

5. The method of claim 1, wherein the Fischer-Tropsch catalyst comprises cobalt.

6. The method of claim 1, wherein the method is carried out at a pressure of from 2 to 10 barg.

7. The method of claim 1, wherein the method is carried out at a gas hourly space velocity of from 500 to 3000 h⁻¹.

8. The method of at claim 1, wherein the inert gas comprises nitrogen and/or the inert gas consists essentially of nitrogen.

9. The method of claim 1, wherein the hydrocarbons comprise wax.

10. The method of claim 9, wherein removing stripped hydrocarbons from the catalyst carrier and the Fischer-Tropsch reactor comprises the use of a first gas liquid separator downstream of the Fischer-Tropsch reactor.

11. The method of claim 10, further comprising maintaining the first temperature until substantially no more wax is collected in the first gas liquid separator.

12. The method of claim 1, wherein the first oxygen content is 0.01 mol. % oxygen, or lower.

13. The method of claim 1, wherein the first temperature is from 150° C. to 250° C.

14. The method of claim 1, wherein the second temperature is from 110° C. to 130° C.

15. The method of a claim 1, wherein the second oxygen content is from 8 to 12 mol. % oxygen.

16. The method of claim 1, further comprising, after increasing the oxygen content of the gas passed to the inlet to a second oxygen content, maintaining the second temperature until no oxidation exotherm is observed, preferably for at least 2 hours, before cooling the catalyst carrier to below 40° C.

17. The method of claim 1, wherein the third oxygen content is from 20 to 22 mol. % oxygen.

18. The method of a claim 1, wherein the gas is recirculated from the outlet to the inlet.

19. The method of claim 1, wherein providing a Fischer-Tropsch catalyst in a catalyst carrier comprises cooling the Fischer-Tropsch catalyst from an operating temperature to the first temperature.

20. The method of claim 1, wherein increasing the oxygen content of the gas comprises introducing air into the inert gas.

21. The method of claim 1, wherein the Fischer-Tropsch catalyst is substantially devoid of hydrocarbons before adjusting the temperature of the Fischer-Tropsch catalyst to the second temperature.

22. (canceled)
